(19) United States
(12) Patent Application Publication
(10) Pub. No.: US 2019/0117504 A1
(43) Pub. Date: Apr. 25, 2019

(54) CARDIOPULMONARY RESUSCITATION CHEST COMPRESSION MACHINE HAVING MULTIPLE MODES

(71) Applicant: PHYSIO-CONTROL, INC., Redmond, WA (US)

(72) Inventors: Erik von Schenck, Lomma (SE); Anders Nilsson, Akarp (SE); Thomas Falk, Staffanstorp (SE)

(21) Appl. No.: 16/168,657

(22) Filed: Oct. 23, 2018

Related U.S. Application Data
(60) Provisional application No. 62/576,579, filed on Oct. 24, 2017.

(51) Int. Cl. A61H 31/00

(52) U.S. Cl. CPC A61H 31/006; A61H 31/005; A61H 2201/5097; A61H 2201/5043; A61H 2201/5007

(57) ABSTRACT

A cardiopulmonary resuscitation (CPR) chest compression device, including a chest compression component structured to deliver chest compressions to a patient, and a controller electrically coupled to the chest compression component. The controller operates the chest compression component to switch between operating at least in a first mode for a first time period and a second mode for a second time period. The first mode includes compressing a chest of a patient at a first rate of compressions, at a first depth for each compression, and a first duty cycle, and the second mode includes compressing a chest of a patient at a second rate of compressions, at a second depth for each compression, and a second duty cycle, at least one of the second rate, the second depth, and the second duty cycle is different from the first rate, the first depth, and the first duty cycle.

### PRIORITY

This disclosure claims benefit of U.S. Provisional Application No. 62/576,579, titled “CPR CHEST COMPRESSION MACHINE (CCCM) CYCLING THROUGH DIFFERENT SETS OF CHEST COMPRESSION PARAMETERS,” filed on Oct. 24, 2017, which is incorporated herein by reference in its entirety.

### BACKGROUND

Cardiopulmonary resuscitation (CPR) is a medical procedure performed on patients to maintain some level of circulatory and respiratory functions when patients otherwise have limited or no circulatory and respiratory functions. CPR is generally not a procedure that restarts circulatory and respiratory functions, but can be effective to preserve enough circulatory and respiratory functions for a patient to survive until the patient's own circulatory and respiratory functions are restored. CPR typically includes frequent torso compressions that usually are performed by pushing on or around the patient's sternum while the patient is lying on the patient's back. For example, torso compressions can be performed as at a rate of about 100 compressions per minute and at a depth of about 5 cm per compression for an adult patient. The frequency and depth of compressions can vary based on a number of factors, such as valid CPR guidelines

Mechanical CPR has several advantages over manual CPR. A person performing CPR, such as a medical first-responder, must exert considerable physical effort to maintain proper compression timing and depth. Over time, fatigue can set in and compressions can become less consistent and less effective. The person performing CPR must also divert mental attention to performing manual CPR properly and may not be able to focus on other tasks that could help the patient. For example, a person performing CPR at a rate of 100 compressions per minute would likely not be able to simultaneously prepare a defibrillator for use to attempt to restart the patient's heart. Mechanical compression devices can be used with CPR to perform compressions that would otherwise be done manually. Mechanical compression devices can provide advantages such as providing constant, proper compressions for sustained lengths of time without fatiguing, freeing medical personnel to perform other tasks besides CPR compressions, and being usable in smaller spaces than would be required by a person performing CPR compressions.

Conventional mechanical compression devices, however, normally operate at a fixed rate, a fixed frequency, and a fixed depth that is preset and cannot be changed. However, there may be benefits to varying the rate, frequency, and/or depth of the compression device during treatment.

### BRIEF DESCRIPTION OF THE DRAWINGS

Aspects, features and advantages of embodiments of the present disclosure will become apparent from the following description of embodiments in reference to the appended drawings in which:

FIG. 1 is an example schematic block diagram of a mechanical CPR device according to some embodiments of the disclosure.

FIG. 2 is an example auto-cycling mode of operation of the mechanical CPR device according to some embodiments of the disclosure.

FIG. 3 is an example auto-cycling mode of operation of the mechanical CPR device according to some embodiments of the disclosure.

FIG. 4 is an operation of the mechanical CPR device according to some embodiments of the disclosure.

### DESCRIPTION

Mechanical CPR is a repeating cycle of chest compressions performed on a patient by a mechanical CPR device. A typical chest compression cycle includes applying a force and/or pressure to a chest of a patient to a particular depth, and then releasing the force and/or pressure. Multiple cycles of chest compressions may be performed on the patient at a particular rate, depth, and duty cycle. A rate of the chest compressions is how many compression cycles are performed within a time period. Generally, the time period is one minute and the rate is measured in compressions, or beats, per minute, which is referred to herein as beats per minute (bpm). A depth is how deep the force and/or pressure is applied. A duty cycle is to the ratio of time the mechanical CPR device is down, or applying force to the chest of the patient versus up, or when released from the chest of a patient. For example, if a cycle is 10 seconds of time, then for a 20% duty cycle, pressure is applied to the patient for 2 seconds, and pressure is released for 8 seconds.

Conventional mechanical CPR devices generally operate with chest compressions having a fixed rate, frequency, and depth that is preset and cannot be changed by a user. Embodiments of the disclosure, however, include mechanical CPR devices that operate with multiple modes of chest compression, each mode having at least one rate, depth, and/or duty cycle different from the other modes.

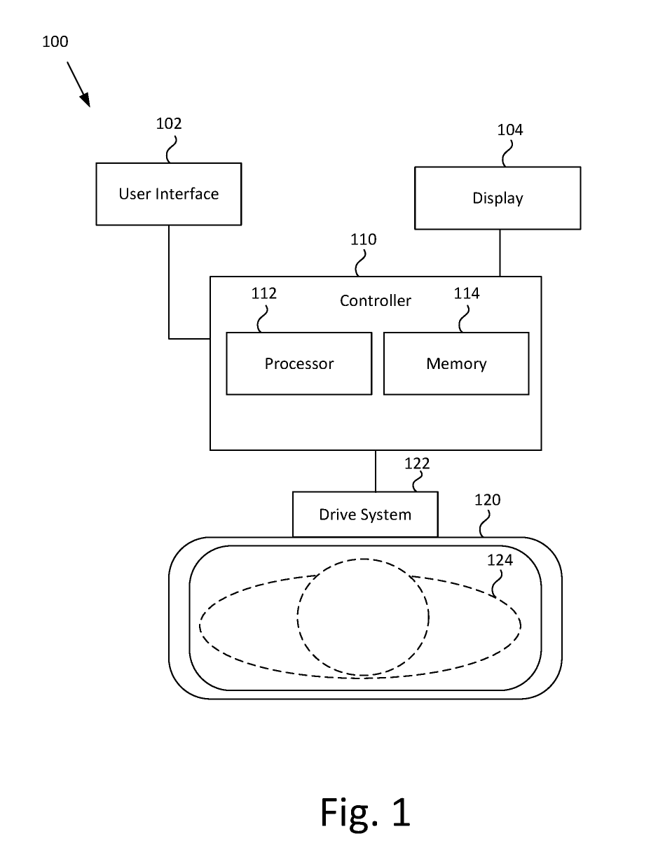

FIG. 1 illustrates an example schematic block diagram of a mechanical CPR device 100. As will be understood by one skilled in the art, the mechanical CPR device 100 may include additional components not shown in FIG. 1. The mechanical CPR device 100 includes a controller 110, which may be in electrical communication with a chest compression mechanism or device 120. The chest compression mechanism 120 may be any component that compresses a chest of a patient, such as a piston based chest compression device or a belt driven device that wraps around a chest of a patient 124. The chest compression mechanism 120 may include a drive system 122 configured to drive the compression mechanism 120 to cause the compression mechanism 120 to perform compressions to a chest of the patient 124. The controller 110, as will be discussed in more detail below, provides instructions to the chest compression mechanism 120 to operate the chest compression mechanism at a number of different rates, depths, and duty cycles, based on the modes stored in memory 114.

The controller 110 may include a processor 112, which may be implemented as any processing circuity, such as, but not limited to, a microprocessor, an application specific integration circuit (ASIC), programmable logic circuits, etc. The processor 112 is configured to execute instructions from memory 114 and may perform any methods and/or associated operations indicated by such instructions. Memory 114 may be implemented as processor cache, random access memory (RAM), read only memory (ROM), solid state memory, hard disk drive(s), and/or any other memory type. Memory 114 acts as a medium for storing data, such as event data, patient data, etc., computer program products, and other instructions. Although memory 114 is shown within the controller 110 in FIG. 1, the memory 114 may also be located remote from controller 110 and be in electrical communication with controller 110. Further, the memory 114 is not limited to a single memory, but may include multiple memories, each memory for storing different information.

The controller 110 may be located separately from the chest compression mechanism 120 and may communicate with the chest compression mechanism 120 through a wired or wireless connection. The controller 110 also electrically communicates through a wired or wireless connection with a user interface 102 and a display 104. As will be understood by one skilled in the art, the controller 110 may also be in electronic communication with a variety of other devices, such as, but not limited to, another communication device, another medical device, etc.

Operations of the mechanical CPR device 100 may be effectuated through the user interface 102. The user interface 102 may be external to or integrated with the display 104. Further, the user interface 102 may be external to or integrated with the mechanical CPR device 100 and may electrically communicate with the controller 110 through a wireless connection. For example, in some embodiments, the user interface 102 may include physical buttons located on the mechanical CPR device 100, while in other embodiments, the user interface 102 may be displayed on the display 104 and may be a touch-sensitive feature of the display 104. In some embodiments, the user interface 102 may be remote from the display 104 such as a keyboard, smartphone, tablet, personal digital assistant (PDA), and the like, in electronic communication with the display 104 and the controller 110. The display 104, as well, may be located on the mechanical CPR device 100, or may be located on a remote device, such as a smartphone, tablet, PDA, and the like, in conjunction with or separate from the user interface 102, and is also in wireless electronic communication with the controller 110.

Unlike a conventional mechanical CPR device, which operates in a single mode having a fixed rate and depth, the controller 110 of embodiments disclosed herein may operate the drive system 122 of the chest compression mechanism 120 in a number of different modes, which may be referred to herein as an auto-cycling operation. Each mode may have at least one of a different rate, depth, and/or duty cycle that the drive system 122 operates the chest compression mechanism 120 based on instructions from the controller 110.

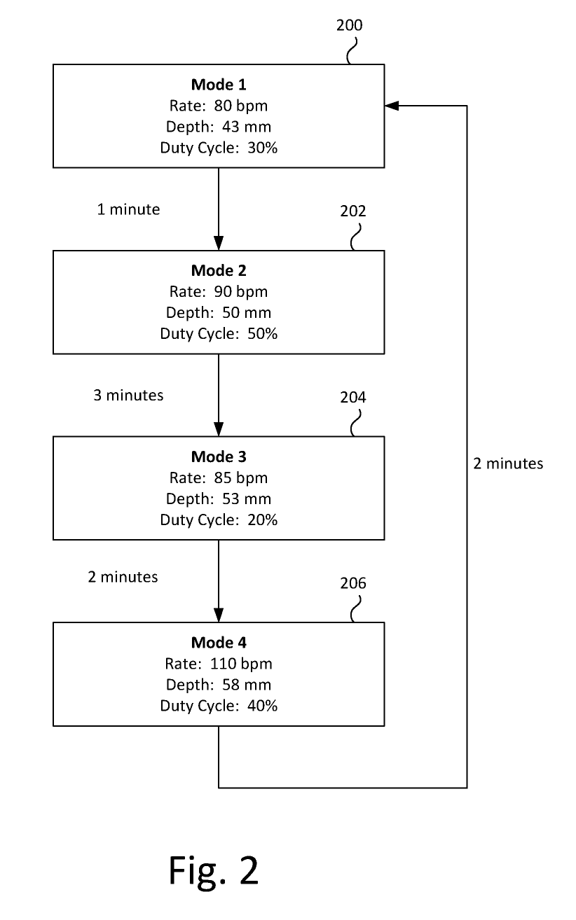

FIG. 2 illustrates an example of an auto-cycling operation of the mechanical CPR device 100. Although four modes are shown in FIG. 2 for ease of illustration, embodiments of the disclosure are not limited to four modes. Any number of modes may be used, such as two modes, five modes, etc. As will be discussed more fully below, the mechanical CPR device 100 may auto-cycle through all four modes or may operate in only a single preset mode selected by a user through the user interface 102.

In FIG. 2, during the first mode 200, the chest compression mechanism 120 may operate at a rate of 80 bpm, a depth of 43 millimeters (mm), and a duty cycle of 30%, that is, a ratio of pressure for 30% of each compression cycle and release for 70% of each compression cycle. This mode may operate for a time period, such as 1 minute, illustrated in FIG. 2.

After the minute has elapsed, the controller 110 may begin operating the chest compression mechanism 120 in a second mode 202. The second mode 202 may include a rate of 90 bpm, a depth of 50 mm, and a duty cycle of 50%. The second mode 202 may be performed for 3 minutes until a third mode 204, including a rate of 85 bpm, a depth of 53 mm, and a duty cycle of 20% may begin. The third mode 204 may operate for 2 minutes, until a fourth mode 206 may being, with a rate of 110 bpm, a depth of 58 mm, and a duty cycle of 40%, which may operate for 2 minutes before returning to the first mode 200. The controller 110 instructs the drive system 122 of the chest compression mechanism 120 to operate in the auto-cycling mode unless a user has selected one of the particular modes 200, 202, 204, or 206 to operate the chest compression mechanism 120 in.

Embodiments of the disclosure, however, are not limited to the modes shown in FIG. 2. Rather, as mentioned above, any number of modes may be used. Further, although the rate, depth, and duty cycle for each mode is different in FIG. 2, embodiments of the disclosure are not limited to this implementation. Each mode may have at least one of a different rate, depth, and/or duty cycle from the other modes. Each mode is also performed for a period of time. The period of time for each mode may be the same in some embodiments, while in other embodiments, at least one period of time is different for at least one of the modes. Each mode may be saved in memory 114.

During normal operation, when a user selects to begin chest compressions, the controller 110 will begin auto-cycling between the preset modes, such as modes 200, 202, 204, and 206 in FIG. 2, to perform chest compressions. The modes 200, 202, 204, and 206 may be displayed on the display 104 for a user to select a particular preset mode 200, 202, 204, and 206 in which to operate the mechanical CPR device 100.

For example, in some embodiments, the preset modes 200, 202, 204, and 206 may be displayed to the user on the display 104 or may be selected by a button located on the mechanical CPR device 100. The user may select one of the modes and the chest compressions will then be performed in accordance with the selected mode until either the chest compressions stop or the user selects the auto-cycling operation. In some embodiments, the default operation of the mechanical CPR device 100 will be the auto-cycling mode and the preset modes will only be performed when selected by a user. In other embodiments, the user may select through the user interface 102 whether to begin chest compressions in either the auto-cycling mode or a particular preset mode.

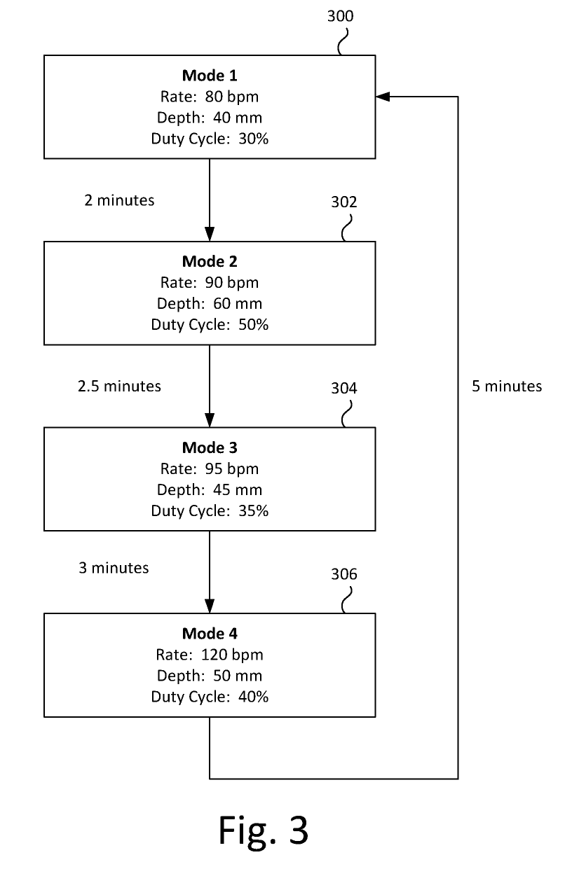

FIG. 3 illustrates another example auto-cycling mode that may be saved in memory 114. In this example, the auto-cycling mode includes a first mode 300, which may operate at a rate of 80 bpm, a depth of 40 mm, and a duty cycle of 30% for three minutes. Then, a second mode 302 may begin at a rate of 90 bpm, 60 mm depth, and 50% duty cycle for two and a half minutes. Once the time period for the second mode 302 is complete, then a third mode 304 may begin with a rate of 95 bpm, a depth of 45 mm, and a duty cycle of 35%, which may operate for three minutes. Finally, a fourth mode 306 may begin, which may be a “turbo” mode, with a rate of 120 bpm, a depth of 50 mm, and a duty cycle of 40% for five minutes, before returning to the first mode 300.

In this example, the mechanical CPR device 100 can begin in a soft mode, such as the first mode 300, when beginning restoration of partial oxygenated blood flow to the brain, heart, and other organs. The controller 110 may then move into a turbo mode through the second mode 302, the third mode 304, and the fourth mode 306 to try to get the heart started.

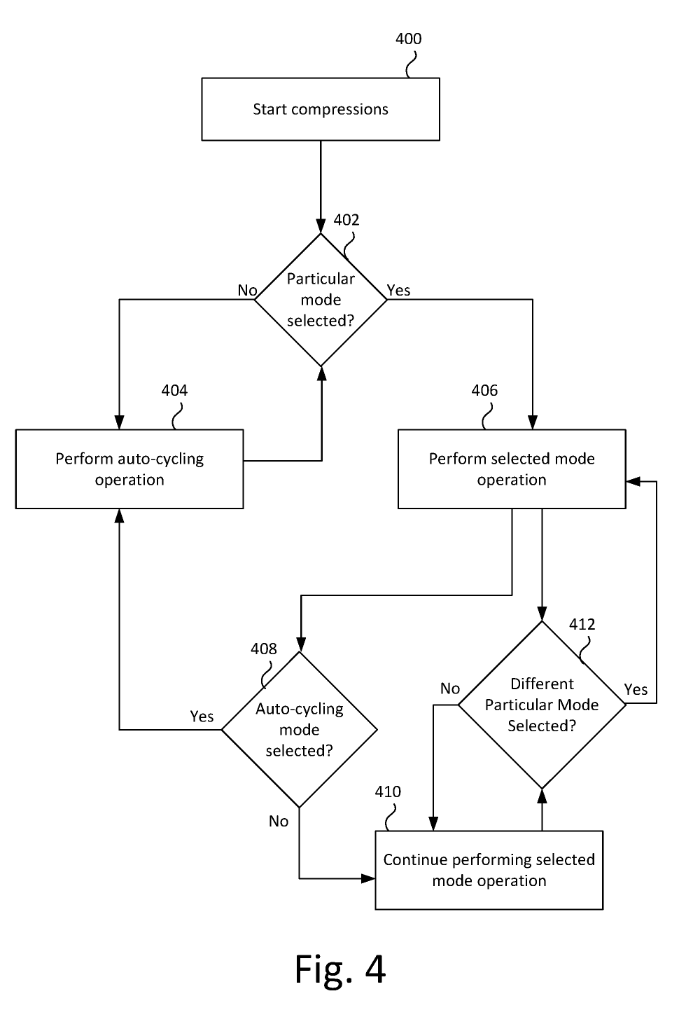

FIG. 4 illustrates an example flow chart illustrating an operation of the controller 110 to instruct the drive system 122 of the chest compression mechanism 120. Initially, a command is received 400 from the user interface 102 at the controller 110 to begin chest compressions. The controller 110 may then determine if a particular mode selection was received 402 from the user interface 102. If no, then the controller 110 instructs the drive system 122 to begin chest compressions in the auto-cycling operation between the different modes, such as the modes shown in FIG. 2, FIG. 3, or other modes that may be saved in memory 114.

Upon receiving a start signal from the user interface 102 in operation 400, the controller 110 may determine in operation 402 if a user has manually selected to begin chest compressions in a particular preset mode. If a particular preset mode is not selected, then the controller 110 can instruct the chest compression mechanism 120 to performing chest compressions in accordance with the auto-cycling operation stored in memory 114 in operation 404. If a particular preset mode has been selected at the user interface 102, then the controller 110 instructs the chest compression mechanism 120 to perform chest compressions in accordance with the selected preset mode in operation 406.

When the auto-cycling mode is being performed in operation 404, if a selection to begin chest compressions in a particular preset mode is received, the controller returns to operation 402. Further, while performing chest compressions in the preset mode, the controller 110 may receive a selection from the user interface 114 at operation 408 to return to perform the auto-cycling operation at operation 404. If such a selection hasn't been received, the controller 110 continues to perform the chest compressions in the selected mode in operation 410. Further, in operation 412, the controller determines if a new particular preset mode has been selected. If yes, the controller returns to operation 406 to perform chest compressions using the newly selected preset mode. If no, then the controller continues in operation 410 performing the selected preset mode.

In some embodiments, as mentioned above, the preset modes may be saved in the memory 114, as well as the corresponding time period for each mode. In some embodiments, the preset modes may not be changed by a user. The controller 110 may then instruct the drive system 122 of the chest compression mechanism 120 to operate according to the auto cycling operation and/or a particular preset mode based on a selection or lack thereof by a user.

In some embodiments, however, a user may change or add modes via the user interface 114 to operate the chest compression mechanism 120. For example, a user may be able to select through the user interface 114 a time period for each mode to operate. In some embodiment, the user may select through the user interface 114 a particular mode and then modify one or more parameters of that mode, which is then stored in memory 114. In other embodiments, the user may set the parameters of each mode in the user interface 114, which are then saved in memory 114, prior to beginning either the auto-cycling operation or a preset mode operation.

In operations where the user sets the parameters for each mode, the parameters may have limits. For example, the rate may be limited between 80-140 bpm, depth may be limited between 4-6 cm, and the duty cycle may be limited to 20-80%. In operations where the modes stored in memory 114 are preset and cannot be changed by a user, the parameters of the modes may be set in accordance with the same parameter limits. That is, the rate may be between 80-140 bpm, depth may be between 4-6 cm, and the duty cycle may be 20-80%.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

We claim:

1. A cardiopulmonary resuscitation (CPR) chest compression device, comprising:
a chest compression component structured to deliver chest compressions to a patient; and
a controller electrically coupled to the chest compression component, the controller configured to operate the chest compression component to switch between operating in a first mode for a first time period and a second mode for a second time period,
the first mode including compressing a chest of a patient at a first rate of compressions, at a first depth for each compression, and a first duty cycle, and
the second mode including compressing a chest of a patient at a second rate of compressions, at a second depth for each compression, and a second duty cycle, at least one of the second rate, the second depth, and the second duty cycle is different from the first rate, the first depth, and the first duty cycle.

2. The CPR chest compression device of claim 1, wherein the controller is further configured to operate the chest compression component to switch between at least the first mode, the second mode, and a third mode, the third mode including operating the CPR chest compression component for a third time period, the third mode including compressing a chest of a patient at a third rate of compressions, a third depth for each compression, and a third duty cycle, at least one of the third rate, the third depth, and the third duty cycle is different from at least one of the first rate, the first depth, and the first duty cycle and at least one of the second rate, the second depth, and the second duty cycle.

3. The CPR chest compression device of claim 2, wherein each of the first rate, the second rate, and the third rate are different.

4. The CPR chest compression device of claim 2, wherein each of the first duty cycle, the second duty cycle, and the third duty cycle are different.

5. The CPR chest compression device of claim 2, wherein each of the first depth, the second depth, and the third depth are different.

6. The CPR chest compression device of claim 2, wherein each of the first time period, the second time period, and the third time period are different.

7. The CPR chest compression device of claim 1, further comprising a user input configured to receive a selection of either the first mode or the second mode.

8. The CPR chest compression device of claim 7, wherein when the selection of the first mode is received, the controller is configured to operate the chest compression component in the first mode and when the selection of the second mode is received, the controller is configured to operate the chest component in the second mode.

9. The CPR chest compression device of claim 8, wherein the user input is configured to receive the selection from a user from a remote device.

10. The CPR chest compression device of claim 8, wherein the user input is further configured to receive a selection to alternate between the first mode and the second mode after receiving the selection of the first mode or the second mode.

11. A method of controlling the administration of cardiopulmonary resuscitation (CPR) through a CPR chest compression device, the method comprising:
selecting a mode from a first mode, a second mode, or a cycle mode;
when the first mode is selected, operating the chest compression device to compress a chest of a patient at a first rate of compressions, a first depth for each compression, and a first duty cycle;
when the second mode is selected, operating the chest compression device to compress a chest of a patient at a second rate of compressions, a second depth for each compression, and a second duty cycle, at least one of the second rate, the second depth, and the second duty cycle is different from the first rate, the first depth, and the first duty cycle; and
when the cycle mode is selected, operating the chest compression device in the first mode for a first time period and switching to operate in the second mode for a second time period.

12. The method of claim 11, wherein the mode further includes a third mode, the method further comprising:
when the third mode is selected, operating the chest compression device to compress a chest of a patient at a third rate of compressions, a third depth for each compression, and a third duty cycle, at least one of the third rate, the third depth, and the third duty cycle is different from the first rate, the first depth, and the first duty cycle, and at least one of the third rate, the third depth, and the third duty cycle is different from the second rate, the second depth, and the second duty cycle; and
when the cycle mode is selected, cycling between the first mode for the first time period, the second mode for the second time period, and the third mode for a third time period.

13. The method of claim 12, wherein each of the first rate, the second rate, and the third rate are different.

14. The method of claim 12, wherein each of the first duty cycle, the second duty cycle, and the third duty cycle are different.

15. The method of claim 12, wherein each of the first depth, the second depth, and the third depth are different.

16. The method of claim 12, wherein each of the first time period, the second time period, and the third time period are different.

17. The method of claim 11, wherein the first rate and the second rate are different, the second duty cycle and the third duty cycle are different, and the first depth and the second depth are different.

18. The method of claim 11, further comprising receiving from a user input a selection of the first mode or the second mode.

19. The method of claim 19, further comprising receiving a selection from the user input to select the cycle mode after receiving the selection of the first mode or the second mode.

20. The method of claim 11, further comprising selecting the cycle mode at a startup of the chest compression device.
